(19) United States
(12) Patent Application Publication
(10) Pub. No.: US 2015/0379892 A1
(43) Pub. Date: Dec. 31, 2015

(54) INFORMATION PROCESSING DEVICE AND STORAGE MEDIUM

(71) Applicant: SONY CORPORATION, Tokyo (JP)

(72) Inventors: Yoichiro SAKO, Tokyo (JP); Yuki KOGA, Tokyo (JP); Yasunori KAMADA, Kanagawa (JP); Kazunori HAYASHI, Tokyo (JP); Takayasu KON, Tokyo (JP); Mitsuru TAKEHARA, Tokyo (JP); Tomoya ONUMA, Shizuoka (JP); Akira TANGE, Tokyo (JP); Hiroyuki HANAYA, Kanagawa (JP)

(73) Assignee: SONY CORPORATION, Tokyo (JP)

(21) Appl. No.: 14/767,386

(22) PCT Filed: Jan. 28, 2014
(86) PCT No.: PCT/JP2014/000431

§ 371 Date: Aug. 12, 2015

(30) Foreign Application Priority Data
Feb. 28, 2013 (JP) 2013-039355

(51) Int. Cl. G09B 19/00; G06K 9/00; G06K 9/72; H04N 5/232; G06F 3/00; G09B 5/02; H04N 5/225

(52) U.S. Cl. CPC G09B 19/0092; G09B 5/02; G06K 9/00597; H04N 5/2253; H04N 5/23293; G06F 3/005; G06K 9/72

(57) ABSTRACT

There is provided an information processing apparatus including circuitry configured to obtain a captured image of food, transmit the captured image of food, receive, from a data providing device, at least one indication of at least one ingredient included within the food of the captured image, and initiate a displaying of the at least one indication to a user, in association with the food of the captured image.

### CROSS REFERENCE TO RELATED APPLICATIONS

This application claims the benefit of Japanese Priority Patent Application JP 2013-039355 filed Feb. 28, 2013, the entire contents of which are incorporated herein by reference.

### TECHNICAL FIELD

The present disclosure relates to an information processing device and a storage medium.

### BACKGROUND ART

Recently, devices that assist dietary lifestyle management are being proposed.

For example, PTL 1 below discloses technology that reduces the user workload of recording meal content for efficient management. Specifically, if a food image is sent together with time and date information from a personal client to a center server, an advisor (expert) at the center server analyzes the image of food, and inputs and sends advice.

Also, PTL 2 below discloses technology that calculates calorie intake and meal chewing time on the basis of a captured image of a dish captured by a wireless portable client, and manages the calorie intake and meal chewing time of the dish in real-time during the meal.

### CITATION LIST

### Patent Literature

PTL 1: JP 2003-85289A

PTL 2: JP 2010-33326A

### SUMMARY

### Technical Problem

However, with the above PTL 1, it is difficult to display advice in real-time regarding food that a user is about to eat.

On the other hand, with the above PTL 2, although a warning is displayed in real-time regarding excessive calorie intake or insufficient meal chewing time, the calculated calorie intake is the total calories for one meal (dish), and the calories per ingredient of the food are not calculated.

Accordingly, the present disclosure proposes a new and improved information processing device and storage medium capable of presenting an indicator depending on the type of food.

### Solution to Problem

According to an embodiment of the present disclosure, there is provided an information processing apparatus including: circuitry configured to obtain a captured image of food; transmit the captured image of food; receive, from a data providing device, at least one indication of at least one ingredient included within the food of the captured image; and initiate a displaying of the at least one indication to a user, in association with the food of the captured image.

According to another embodiment of the present disclosure, there is provided a method including: obtaining a captured image of a food; transmitting the captured image; receiving, from a data providing device, at least one indication of at least one ingredient included within the food of the captured image; and displaying the at least one indication to a user, in association with the food of the captured image.

According to another embodiment of the present disclosure, there is provided a non-transitory computer-readable medium having embodied thereon a program, which when executed by a computer causes the computer to perform a method, the method including: obtaining a captured image of a food; transmitting the captured image; receiving, from a data providing device, at least one indication of at least one ingredient included within the food of the captured image; and displaying the at least one indication to a user, in association with the food of the captured image.

According to another embodiment of the present disclosure, there is provided a data providing device including: an image obtaining unit configured to obtain a captured image of food; a type distinguishing unit configured to distinguish at least one ingredient included within the food of the captured image; an indicator generating unit configured to generate at least one indication in relation to the at least one ingredient; and a display data providing unit configured to provide the generated at least one indication to be displayed in association with the food of the captured image, wherein at least one of the image obtaining unit, the type distinguishing unit, the indicator generating unit, and the display data providing unit is implemented via a processor.

According to another embodiment of the present disclosure, there is provided a data providing method including: obtaining a captured image of food; distinguishing at least one ingredient included within the food of the captured image; generating at least one indication in relation to the at least one ingredient; and providing the generated at least one indication to be displayed in association with the food of the captured image.

### Advantageous Effects of Invention

According to the present disclosure as described in embodiments, it becomes possible to present an indicator depending on the type of food.

### BRIEF DESCRIPTION OF DRAWINGS

FIG. 1 is a diagram summarizing a display control process according to an embodiment of the present disclosure.

FIG. 2 is a block diagram illustrating an exemplary internal configuration of an HMD according to an embodiment.

FIG. 3 is a flowchart illustrating an indicator display process according to an embodiment.

FIG. 4 is a flowchart illustrating a gaze-dependent indicator display process according to an embodiment.

FIG. 5 is a flowchart illustrating an upper limit-dependent indicator display process according to an embodiment.

FIG. 6 is a diagram illustrating an example of an estimated dish confirmation screen according to an embodiment.

FIG. 7 is a diagram illustrating an example of an indicator table image indicating calories for each ingredient according to an embodiment.

FIG. 8 is a diagram illustrating an example of an indicator table image indicating calories for each ingredient according to an embodiment.

FIG. 9 is a diagram illustrating an example of an indicator table image indicating nutritional components of food according to an embodiment.

FIG. 10 is a diagram for explaining the case of displaying an indicator near an eating target according to an embodiment.

FIG. 11 is a diagram for explaining an exemplary display indicating whether respective ingredients are suitable/unsuitable according to an embodiment.

FIG. 12 is a diagram for explaining the case of illustrating a remaining food indicator according to an embodiment.

FIG. 13 is a diagram for explaining the case of illustrating a one-week total intake indicator according to an embodiment.

FIG. 14 is a diagram for explaining a display of food preparation-dependent indicators according to an embodiment.

### DESCRIPTION OF EMBODIMENTS

Hereinafter, embodiments of the present disclosure will be described in detail and with reference to the attached drawings. Note that, in this specification and the appended drawings, structural elements that have substantially the same function and structure are denoted with the same reference numerals, and repeated explanation of these structural elements is omitted.

Hereinafter, the description will proceed in the following order.

1. Summary of display control process according to embodiments of present disclosure

2. Basic configuration and operational process of HMD

2-1. Basic configuration of HMD

2-2. Operational process of HMD

3. Screen display examples

3-1. Indicator display

3-2. Suit able/unsuitable display

3-3. Display of calculated indicator based on accumulated indicator

3-4. Display of preparation method-dependent indicator

4. Conclusion

### 1. SUMMARY OF DISPLAY CONTROL PROCESS ACCORDING TO EMBODIMENTS OF PRESENT DISCLOSURE

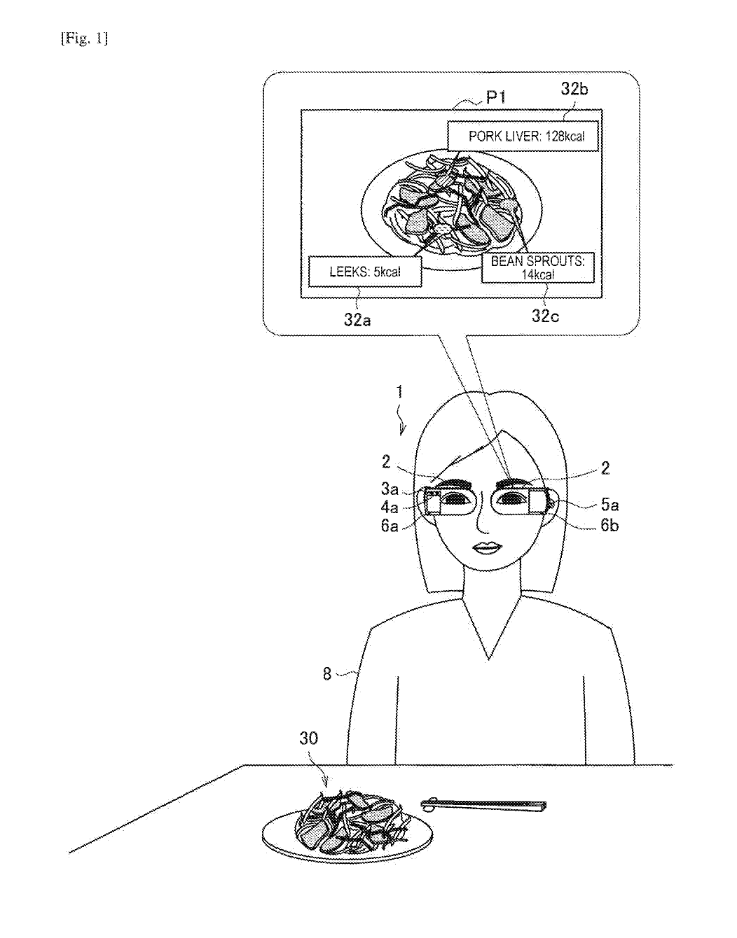

First, a display control process according to an embodiment of the present disclosure will be summarized with reference to FIG. 1.

FIG. 1 is a diagram summarizing a display control process according to an embodiment of the present disclosure. As illustrated in FIG. 1, a user 8 is wearing an eyeglasses-style head-mounted display (HMD) 1. The HMD 1 includes a wearing unit having a frame structure that wraps halfway around the back of the head from either side of the head, for example, and is worn by the user 8 by being placed on the pinna of either ear, as illustrated in FIG. 1.

Also, the HMD 1 is configured such that, in the worn state, a pair of display units 2 for the left eye and the right eye are placed immediately in front of either eye of the user 8, or in other words at the locations where the lenses of ordinary eyeglasses are positioned. A captured image of a real space captured with an image capture lens 3a, for example, is displayed on the display units 2. The display units 2 may also be transparent, and by having the HMD 1 put the display units 2 in a see-through state, or in other words a transparent or semi-transparent state, ordinary activities are not impaired even if the user 8 wears the HMD 1 continuously like eyeglasses.

Also, as illustrated in FIG. 1, in the HMD 1, the image capture lens 3a is placed facing forward, so as to capture the direction in which the user sees as the photographic direction while in a state of being worn by the user 8. Furthermore, a light emitter 4a that provides illumination is provided in the image capture direction by the image capture lens 3a. The light emitter 4a is formed by a light-emitting diode (LED), for example.

Also, although only illustrated on the left eye side in FIG. 1, a pair of earphone speakers 5a which may be inserted into a user's right ear canal and left ear canal in the worn state are provided. Also, microphones 6a and 6b that pick up external sounds are placed to the right of the display unit 2 for the right eye, and to the left of the display unit 2 for the left eye.

Note that the external appearance of the HMD 1 illustrated in FIG. 1 is an example, and that a variety of structures by which a user may wear the HMD 1 are conceivable. It is sufficient for the HMD 1 to be formed as a worn unit of the eyeglasses type or head-mounted type, and at least for an embodiment, it is sufficient for a display unit 2 to be provided close in front of a user's eye. Also, besides the display units 2 being provided as a pair corresponding to either eye, a configuration providing a single display unit 2 corresponding to an eye on one side is also acceptable.

Also, although the image capture lens 3a and the light emitter 4a that provides illumination are placed facing forward on the side of the right eye in the example illustrated in FIG. 1, the image capture lens 3a and the light emitter 4a may also be placed on the side of the left eye, or placed on both sides.

It is also acceptable to provide a single earphone speaker 5a to be worn in only one ear, rather than as left and right stereo speakers. Likewise, a microphone may be one of either the microphone 6a or 6b.

Furthermore, a configuration not equipped with the microphones 6a and 6b or the earphone speakers 5a is also conceivable. A configuration not provided with the light emitter 4a is also conceivable.

The above thus describes an external configuration of the HMD 1 illustrated in FIG. 1. In the present specification, an HMD 1 is used as an example of an information processing device that conducts indicator display control, but an information processing device according to the present disclosure is not limited to an HMD 1. For example, the information processing device may also be a smartphone, a mobile phone, a personal digital assistant (PDA), a personal computer (PC), a tablet device, or the like.

Herein, with the technology described in the above PTL 2 as a device that assists dietary lifestyle, the total calories of one meal (dish) are calculated. However, a user is not strictly limited to eating an entire dish, and in addition, cases in which a user prefers to eat only specific ingredients from a dish are also anticipated. Also, since calories and nutritional components differ by ingredient, presenting indicators such as the calories and nutritional components per ingredient greatly improves the utility of technology that assists dietary lifestyle.

Furthermore, in cases in which improvements in dietary lifestyle are demanded due to problems of lifestyle-related diseases or the like, the intake and numerical values of calories, fat, sugar, purines, cholesterol, and the like become problematic. A user is responsible for regularly taking care to recognize preferred and non-preferred food substances for dietary lifestyle improvement. For example, persons at risk of hyperlipidemia, persons with high total cholesterol values, persons with high LDL cholesterol (bad cholesterol) values, and the like are responsible for paying attention to cholesterol.

In this case, preferred food substances may include food substances with low cholesterol and food substances high in unsaturated fatty acids that reduce cholesterol. Food substances with low cholesterol include egg whites, tofu, lean tuna, chicken breast, natto, clams, milk, spinach, potatoes, and strawberries, for example. Meanwhile, food substances high in unsaturated fatty acids that reduce cholesterol include blue-backed fish (such as mackerel, saury, yellowtail, sardines, and tuna), and vegetable oils (such as olive oil, safflower oil, canola oil, and sesame oil). In addition, food substances that help to reduce cholesterol include broccoli, Brussels sprouts, greens, bell peppers, lotus root, burdock root, dried strips of daikon radish, natto, mushrooms, and seaweed, and these may be said to be preferable food substances.

On the other hand, non-preferred food substances may include food substances with high cholesterol and food substances high in saturated fatty acids that increase cholesterol. Food substances with high cholesterol include egg yolks, chicken eggs, broiled eel, chicken liver, beef tongue, quail eggs, conger eel, raw sea urchin, smelt, beef liver, pork liver, beef ribs, beef giblets, pork shoulder, chicken thighs, chicken wings, and gizzards, for example. Also, food substances high in saturated fatty acids that increase cholesterol include fatty meat such as rib and loin meat, chicken skin, bacon, cheese, dairy cream, butter, lard, and Western confectionery using large amounts of butter and dairy cream, for example.

However, there is a large amount of information on such food substances as above, and it is difficult for a user to continually ingest preferred food substances, as in some cases the user may forget during a meal, or unexpected food substances may be non-preferred.

Accordingly, focusing on the above circumstances led to the creation of a display control system according to embodiments of the present disclosure. A display control system according to embodiments of the present disclosure is able to present an indicator depending on the type of food.

Specifically, with the HMD 1 (information processing device) illustrated in FIG. 1, a dish 30 placed on a table is captured by the image capture lens 3a, the types of food in the captured image are distinguished by ingredient, and an indicator for each ingredient is generated on the basis of the distinguished results. Subsequently, by displaying an indicator for each ingredient on the display units 2, the HMD 1 is able to present an indicator for each ingredient to a user during a meal. An indicator refers to a value of calories, vitamins, fat, sugar, purines, or cholesterol, for example.

As an exemplary indicator display, an image P1 that includes calorie displays for each ingredient (leeks, bean sprouts, and pork liver) may be displayed on the display units 2, as illustrated in FIG. 1, for example. As illustrated in FIG. 1, the HMD 1 displays the calorie display 32a in correspondence with the position of leeks, displays the calorie display 32b in correspondence with the position of pork liver, and displays the calorie display 32c in correspondence with the position of bean sprouts. At this point, the HMD 1 may also superimpose the calorie displays 32a to 32c onto a captured image, or set the display units 2 to semi-transparent and then display the calorie displays 32a to 32c in correspondence with each ingredient existing in a real space.

In addition, the HMD 1 may determine, according to the distinguishing of each ingredient in a captured image, whether or not that ingredient is preferable for the user, and display the determination result on the display units 2. For example, the HMD 1 conducts display control to display an image that recommends eating at a position corresponding to the above food substances with low cholesterol or the above food substances high in unsaturated fatty acids that reduce cholesterol. In addition, the HMD 1 conducts display control to display an image that forbids eating at a position corresponding to the above food substances with high cholesterol or the above food substances high in saturated fatty acids that increase cholesterol, or outputs a warning sound.

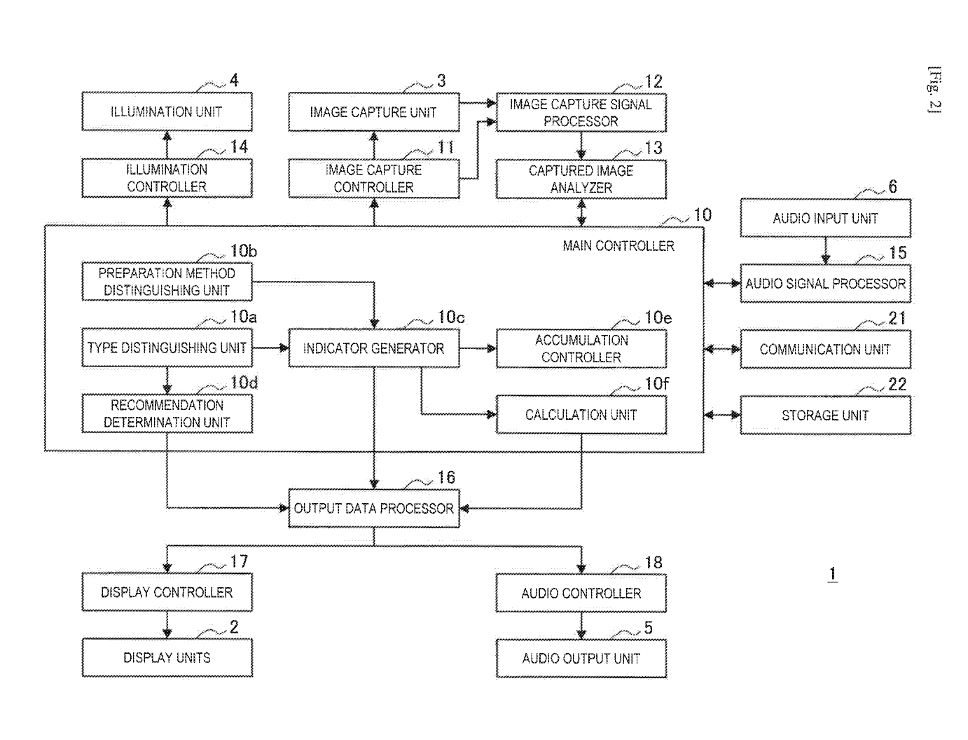

The above thus summarizes a display control process according to an embodiment. Next, a basic configuration and operational process of an HMD 1 (information processing device) that conducts a display control process according to an embodiment will be described with reference to FIGS. 2 to 4.

### 2. BASIC CONFIGURATION AND OPERATIONAL PROCESS OF HMD

<2-1. Basic Configuration of HMD>

FIG. 2 is a diagram illustrating an exemplary internal configuration of an HMD 1 according to an embodiment. As illustrated in FIG. 2, an HMD 1 according to an embodiment includes display units 2, an image capture unit 3, an illumination unit 4, an audio output unit 5, an audio input unit 6, a main controller 10, an image capture controller 11, an image capture signal processor 12, a captured image analyzer 13, an illumination controller 14, an audio signal processor 15, an output data processor 16, a display controller 17, an audio controller 18, a communication unit 21, and a storage unit 22.

(Main Controller 10)

The main controller 10 is made up of a microcontroller equipped with a central processing unit (CPU), read-only memory (ROM), random access memory (RAM), non-volatile memory, and an interface unit, for example, and controls the respective components of the HMD 1.

Also, as illustrated in FIG. 2, the main controller 10 functions as a type distinguishing unit 10a, a preparation method distinguishing unit 10b, an indicator generator 10c, a recommendation determination unit 10d, an accumulation controller 10e, and a calculation unit 10f.

The type distinguishing unit 10a distinguishes types of food in a captured image, and supplies distinguished results to the indicator generator 10c and the recommendation determination unit 10d. Specifically, the type distinguishing unit 10a distinguishes the type of each ingredient included in food. For example, from a captured image capturing the dish 30 of stir-fried liver and leeks (also called stir-fried leeks with liver) illustrated in FIG. 1, “leeks”, “pork liver”, and “bean sprouts” are distinguished as the type of each ingredient included in the dish 30. Types of ingredients may also be distinguished on the basis of a captured image analysis result from the captured image analyzer 13. Specifically, the type distinguishing unit 10a is able to distinguish types of ingredients using color and shape features of ingredients extracted from a photograph, and data for distinguishing ingredients that is stored in the storage unit 22. Types of ingredients may also be distinguished on the basis of smell data sensed by a smell sensor (not illustrated). Herein, a smell sensor may be configured using multiple types of metal-oxide-semiconductor sensor elements, for example. Ordinarily, a metal-oxide-semiconductor is in a state of low conductivity, in which oxygen present in the air is adsorbed on the surface of crystal grains, and this oxygen traps electrons in the crystals which are the carriers. In this state, if smell components adhere to the surface of the metal-oxide-semiconductor, oxidation of the smell components takes away adsorbed oxygen on the surface, and the conductivity increases. Since the change in conductivity differs according to differences in the type and grain size of the metal-oxide-semiconductor, and the catalyst to be added, smell components are identified by utilizing this property. Furthermore, types of ingredients may also be distinguished on the basis of various measurement data detected by a salt concentration sensor, ion concentration sensor, or pH sensor (none illustrated) provided at the tip of chopsticks or a spoon. Also, types of ingredients may be comprehensively distinguished by combining captured image analysis results from the captured image analyzer 13, smell data detected by a smell sensor, and various measurement data.

The preparation method distinguishing unit 10b distinguishes a preparation method of food in a captured image (such as stir-fried, grilled, boiled, fried, steamed, raw, or dressed), and supplies distinguished results to the indicator generator 10c. Preparation methods may be distinguished on the basis of a captured image analysis result from the captured image analyzer 13, smell data sensed by a smell sensor (not illustrated), or thermal image data acquired by a thermal image sensor (not illustrated). Specifically, the preparation method distinguishing unit 10b is able to distinguish preparation methods by using a dish's color (such as the browning color) or shininess (oil shininess) features extracted from a photograph, and data for distinguishing preparation methods that is stored in the storage unit 22. For example, from a captured image capturing the dish 30 of stir-fried liver and leeks illustrated in FIG. 1, “stir-fried” is distinguished as the preparation method of the dish 30 from factors such as the browning color and oil shininess of the dish 30. Note that in the case in which there is a preparation monitoring result associated with the dish 30 (a preparation indicator generated during the preparation process), a preparation method may be distinguished on the basis of that monitoring result.

The indicator generator 10c generates an indicator depending on a type of food distinguished by the type distinguishing unit 10a. In the present specification, an indicator refers to a numerical value of calories, vitamins, fat, protein, carbohydrates, calcium, magnesium, dietary fiber, potassium, iron, retinol, sugar, salt, purines, or cholesterol, for example. The indicator generator 10c references data for generating indicators that is included in the storage unit 22, and according to the type of an ingredient, extracts indicators included in that ingredient. In the data for generating indicators, types of ingredients and indicators for those ingredients are associated. The indicator generator 10c may also generate values for indicators included in an ingredient according to an amount (mass) of that ingredient estimated by image analysis.

Also, since indicators change according to preparation method in some cases depending on the nutrient properties, the indicator generator 10c may also re-generate an indicator according to a preparation method distinguished by the preparation method distinguishing unit 10b. Specifically, the indicator generator 10c is able to re-generate an indicator by referencing data related to changes in respective indicators associated preparation methods.

Furthermore, the indicator generator 10c may also generate a specific indicator according to a user's medical information (including disease history and medication history), health information (include current physical condition information), genetic information, predisposition information (including allergy information), or the like, and a type of food distinguished by the type distinguishing unit 10a. A specific indicator refers to an indicator that indicates a component that warrants particular attention on the basis of a user's medical information of the like, for example. For example, on the basis of a user's medical information or health information, the indicator generator 10c generates an indicator indicating cholesterol or an indicator indicating salt content, rather than an indicator indicating calories. The above medical information, health information, genetic information, predisposition information, and the like may be extracted from the storage unit 22, or acquired from a designated server via the communication unit 21. Also, in the case in which the HMD 1 is provided with a biological sensor that detects a user's biological information (such as blood pressure, body temperature, pulse, or brain waves), the indicator generator 10c is able to use information detected from the biological sensor as current health information. Furthermore, a user's biological information may be acquired via the communication unit 21 of the HMD 1 from a communication unit in a user-owned biological information detection device (not illustrated) separate from the HMD 1, and may be used as current health information.

The recommendation determination unit 10d determines whether or not respective ingredients are suitable for a user, on the basis of the types of respective ingredients distinguished by the type distinguishing unit 10a. The question of suitable or unsuitable may be determined on the basis of data on ingredients generally considered suitable/unsuitable, or determined on the basis of a user's medical information, health information, or the like. Ingredients generally considered suitable may include ingredients that warm the body, for example. Also, in cases such as where a user has a lifestyle-related disease or is responsible for paying attention to cholesterol intake as discussed earlier, suitable food substances may include with low cholesterol and food substances high in unsaturated fatty acids that reduce cholesterol. On the other hand, unsuitable food substances may include food substances with high cholesterol and food substances high in saturated fatty acids that increase cholesterol. Also, the recommendation determination unit 10d supplies determination results to the output data processor 16.

The accumulation controller 10e applies control to accumulate indicators generated by the indicator generator 10c in the storage unit 22. More specifically, the accumulation controller 10e applies control to accumulate indicators for ingredients eaten by a user from among the indicators generated by the indicator generator 10c.

The calculation unit 10f calculates a new indicator value on the basis of an indicator accumulated in the storage unit 22 and an indicator currently generated by the indicator generator 10c. For example, the calculation unit 10f is able to calculate a total intake indicator for a designated period by adding an indicator for ingredients currently being ingested to indicators accumulated in the storage unit 22. Also, the calculation unit 10f is able to calculate a remaining future available intake indicator by subtracting an indicator for a designated period being stored in the storage unit 22 and an indicator for ingredients being currently ingested from an ideal total intake indicator for a designated period. The calculation unit 10f supplies calculated, new indicators to the output data processor 16.

(Image Capture Unit)

The image capture unit 3 includes a lens subsystem made up of the image capture lens 3a, a diaphragm, a zoom lens, a focus lens, and the like, a driving subsystem that causes the lens subsystem to conduct focus operations and zoom operations, a solid-state image sensor array that generates an image capture signal by photoelectric conversion of captured light obtained with the lens subsystem, and the like. The solid-state image sensor array may be realized by a charge-coupled device (CCD) sensor array or a complementary metal-oxide-semiconductor (CMOS) sensor array, for example.

(Image Capture Controller)

The image capture controller 11 controls operations of the image capture unit 3 and the image capture signal processor 12 on the basis of instructions from the main controller 10. For example, the image capture controller 11 controls the switching on/off of the operations of the image capture unit 3 and the image capture signal processor 12. The image capture controller 11 is also configured to apply control (motor control) causing the image capture unit 3 to execute operations such as autofocus, automatic exposure adjustment, diaphragm adjustment, and zooming. The image capture controller 11 is also equipped with a timing generator, and controls signal processing operations with timing signals generated by the timing generator for the solid-state image sensors as well as the sample and hold/AGC circuit and video A/D converter of the image capture signal processor 12. In addition, this timing control enables variable control of the image capture frame rate.

Furthermore, the image capture controller 11 controls image capture sensitivity and signal processing in the solid-state image sensors and the image capture signal processor 12. For example, as image capture sensitivity control, the image capture controller 11 is able to conduct gain control of signals read out from the solid-state image sensors, set the black level, control various coefficients for image capture signal processing at the digital data stage, control the correction magnitude in a shake correction process, and the like.

(Image Capture Signal Processor)

The image capture signal processor 12 is equipped with a sample and hold/automatic gain control (AGC) circuit that applies gain control and waveform shaping to signals obtained by the solid-state image sensors of the image capture unit 3, and a video analog/digital (A/D) converter. Thus, the image capture signal processor 12 obtains an image capture signal as digital data. The image capture signal processor 12 also conducts white balance processing, luma processing, chrome signal processing, shake correction processing, and the like on an image capture signal.

(Captured Image Analyzer)

The captured image analyzer 13 is an example of a configuration for acquiring external information. Specifically, the captured image analyzer 13 analyzes image data (a captured image) that has been captured by the image capture unit 3 and processed by the image capture signal processor 12, and obtains information on an image included in the image data.

Specifically, the captured image analyzer 13 conducts analysis such as point detection, line/edge detection, and area segmentation on image data, for example, and outputs analysis results to the type distinguishing unit 10a and the preparation method distinguishing unit 10b of the main controller 10.

(Illumination Unit, Illumination Controller)

The illumination unit 4 includes the light emitter 4a illustrated in FIG. 1 and a light emission circuit that causes the light emitter 4a (an LED, for example) to emit light. The illumination controller 14 causes the illumination unit 4 to execute light-emitting operations, according to control by the main controller 10. By attaching the light emitter 4a in the illumination unit 4 as a unit that provides illumination in front as illustrated in FIG. 1, the illumination unit 4 conducts illumination operations in the direction of a user's line of sight.

(Audio Input Unit, Audio Signal Processor)

The audio input unit 6 includes the microphones 6a and 6b illustrated in FIG. 1, as well as a mic amp unit and A/D converter that amplifies and processes an audio signal obtained by the microphones 6a and 6b, and outputs audio data to the audio signal processor 15. The audio signal processor 15 conducts processing such as noise removal and source separation on audio data obtained by the audio input unit 6. Processed audio data is then supplied to the main controller 10. Equipping an HMD 1 according to an embodiment with the audio input unit 6 and the audio signal processor 15 enables voice input from the user, for example.

(Output Data Processor)

The output data processor 16 includes functions that process data for output from the display units 2 or the audio output unit 5, and is formed from a video processor, a digital signal processor, a D/A converter, and the like, for example. Specifically, the output data processor 16 generates display image data, and conducts luma level adjustment, color correction, contrast adjustment, sharpness (edge enhancement) adjustment, and the like on the generated display image data. The output data processor 16 may also generate an indicator display image on the basis of an indicator depending on a type of food generated by the indicator generator 10c of the main controller 10, and may also generate a display image of a new indicator on the basis of a new indicator calculated by the calculation unit 10f. Also, the output data processor 16 may generate a display image indicating whether or not something is suitable, on the basis of a recommendation determination result depending on a type of food determined by the recommendation determination unit 10d. The output data processor 16 supplies processed display image data to the display controller 17.

The output data processor 16 also generates audio signal data, and conducts volume adjustment, sound quality adjustment, acoustic effects, and the like on the generated audio signal data. The output data processor 16 may also generate audio signal data announcing whether or not something is suitable, on the basis of a recommendation determination result depending on a type of food determined by the recommendation determination unit 10d of the main controller 10. The output data processor 16 supplies processed audio signal data to the audio controller 18.

Note that the output data processor 16 may also generate driving signal data for producing vibration from a vibration notification unit (not illustrated) formed by a driving motor or the like. The output data processor 16 generates a driving signal announcing whether or not something is suitable, on the basis of a recommendation determination result depending on a type of food determined by the recommendation determination unit 10d of the main controller 10.

(Display Controller)

The display controller 17, according to control from the main controller 10, conducts driving control for displaying display image data supplied from the output data processor 16 on the display units 2. The display controller 17 may be made up of a pixel driving circuit for causing display in display units 2 realized as liquid crystal displays, for example. The display controller 17 is also able to control the transparency of each pixel of the display units 2, and put the display units 2 in a see-through state (transparent state or semi-transparent state).

Specifically, a display controller 17 according to an embodiment controls the display units 2 to display an image generated by the output data processor 16 on the basis of an indicator depending on a type of food generated by the indicator generator 10c. In addition, a display controller 17 according to an embodiment may also control the display units 2 to display an image generated by the output data processor 16 on the basis of a recommendation result (suitable or not) per type of food determined by the recommendation determination unit 10d. At this point, the display controller 17 may also apply control to display an image of an indicator or recommendation result in correspondence with the position of each ingredient in the food. Also, the display controller 17 may also display an indicator or recommendation result near an ingredient that a user is about to eat, and move the display position of the image of the indicator or recommendation result according to the positional movement of the ingredient during eating.

In addition, a display controller 17 according to an embodiment may also control the display units 2 to display an image generated by the output data processor 16 on the basis of a new indicator calculated by the calculation unit 10f.

In addition, a display controller 17 according to an embodiment displays a captured image on the display units 2 in real-time, and additionally superimposes an image illustrating indicators, recommendation results, or the like in correspondence with the positions of respective ingredients in the captured image being displayed. Alternatively, the display controller 17 may apply control to put the display units 2 in a see-through state (without displaying a captured image), and display an image illustrating indicators, recommendation results, or the like in correspondence with the positions of ingredients existing in a real space.

(Display Units)

The display units 2, according to control from the display controller 17, display a captured image, or an image illustrating indicators, recommendation results, or the like for respective ingredients.

(Audio Controller)

The audio controller 18, according to control from the main controller 10, applies control to output audio signal data supplied from the output data processor 16 from the audio output unit 5. More specifically, the audio controller 18 applies control to announce an indicator generated by the indicator generator 10c, announce an indicator newly calculated by the calculation unit 10f, or announce a suitable/unsuitable ingredient determined by the recommendation determination unit 10d.

(Audio Output Unit)

The audio output unit 5 includes the pair of earphone speakers 5a illustrated in FIG. 1, and an amp circuit for the earphone speakers 5a. Also, the audio output unit 5 made be configured as what is called a bone conduction speaker. The audio output unit 5, according to control from the audio controller 18, outputs (plays back) audio signal data.

(Storage Unit)

The storage unit 22 is a member that records or plays back data with respect to a designated recording medium. The storage unit 22 is realized by a hard disk drive (HDD), for example. Obviously, various media such as flash memory or other solid-state memory, a memory card housing solid-state memory, an optical disc, a magneto-optical disc, and holographic memory are conceivable as the recording medium, and it is sufficient to configure the storage unit 22 to be able to execute recording and playback in accordance with the implemented recording medium.

Also, a storage unit 22 according to an embodiment stores data for distinguishing ingredients that is used by the type distinguishing unit 10a, data for distinguishing preparation methods that is used by the preparation method distinguishing unit 10b, data for distinguishing indicators that is used by the indicator generator 10c, and data for determining recommendations that is used by the recommendation determination unit 10d. Also, the storage unit 22 stores a user's medical information, health information, genetic information, predisposition information, and the like. Furthermore, the storage unit 22 stores indicators whose accumulation is controlled by the accumulation controller 10e.

(Communication Unit)

The communication unit 21 sends and receives data to and from external equipment. The communication unit 21 communicates wirelessly with external equipment directly or via a network access point, according to a scheme such as a wireless local area network (LAN), Wi-Fi (Wireless Fidelity, registered trademark), infrared communication, or Bluetooth (registered trademark).

The above thus describes in detail an internal configuration of an HMD 1 according to an embodiment. Note that although the audio output unit 5, audio input unit 6, audio signal processor 15, and audio controller 18 are illustrated as an audio-related configuration, it is not strictly necessary to provide all of the above. Also, although the communication unit 21 is illustrated as part of the configuration of the HMD 1, it is not strictly necessary to provide the communication unit 21.

According to the above configuration, an HMD 1 according to an embodiment is able to display indicators in real-time on the display units 2 in accordance with respective ingredients of food in a captured image captured by the image capture unit 3, and assist the dietary lifestyle of the user 8. Next, an operational process of an HMD 1 according to an embodiment will be described.

2-2. Operational Process of HMD

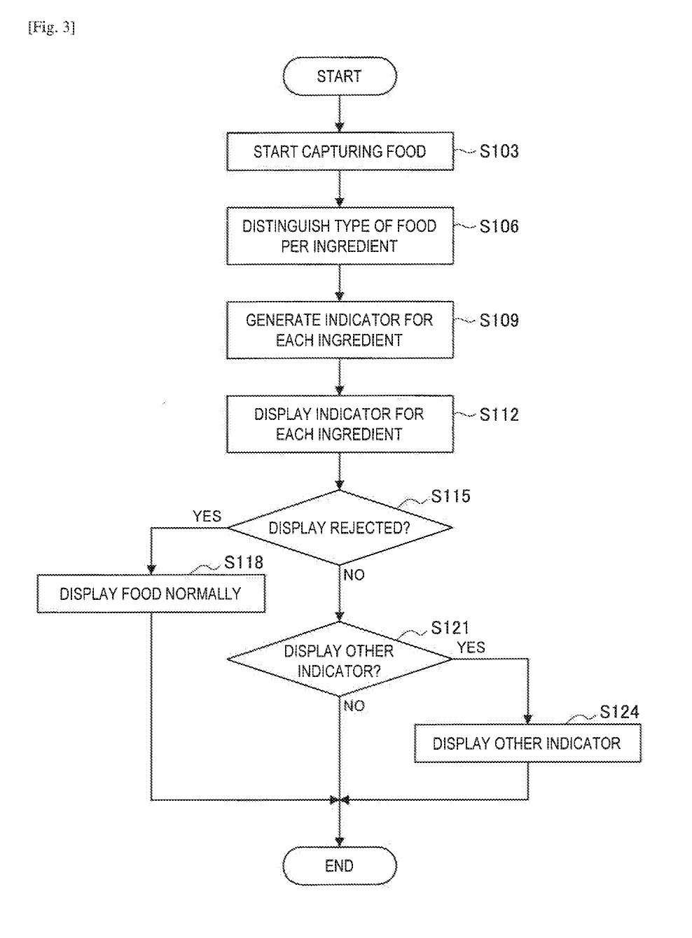

An HMD 1 according to an embodiment is worn by the user 8, and applies control to display indicators for respective ingredients in real-time while the user is eating. An indicator display process by such an HMD 1 will be specifically described hereinafter with reference to FIGS. 3 to 5.

(2-2-1. Indicator Display Process)

FIG. 3 is a flowchart illustrating an indicator display process according to an embodiment. As illustrated in FIG. 3, first, in step S103 the HMD 1 starts capturing food with the image capture unit 3.

Next, in step S106, the type distinguishing unit 10a of the HMD 1 distinguishes a per-ingredient type of food in the image, on the basis of a captured image of food captured by the image capture unit 3. Specifically, the type distinguishing unit 10a distinguishes the types of respective ingredients on the basis of color and shape features of respective objects extracted from an image. The type distinguishing unit 10a outputs distinguished results to the indicator generator 10c.

Subsequently, in step S109, the indicator generator 10c generates indicators for respective ingredients, according to the types of respective ingredients distinguished by the type distinguishing unit 10a. Specifically, the indicator generator 10c extracts a designated indicator associated with a distinguished type of ingredient from the data for distinguishing ingredients that is stored in the storage unit 22, which is generated as an indicator for that ingredient. Note that the indicator generator 10c may also generate an indicator depending on a size or amount of the relevant ingredient, which is estimated on the basis of a captured image. The indicator generator 10c supplies a generated indicator to the output data processor 16.

Next, in step S112, the display controller 17 controls the display units 2 to display an image including indicators for respective ingredients supplied from the output data processor 16. For example, as illustrated in FIG. 1, the display controller 17 applies control to display calorie displays 32a to 32c for respective ingredients at positions corresponding to the respective ingredients.

Subsequently, in the case where the user gives display rejection instructions (S115/Yes), in step S118 the HMD 1 applies control to hide the indicators and display food normally. Note that the normal display control for food may be a transparency control for the display units 2. Also, display rejection instructions from a user are voice input from the audio input unit 6, or a gesture input from the image capture unit 3, for example.

Next, in the case where the user gives display instructions for another indicator (S121/Yes), in step S124 the HMD 1 applies control to display another indicator. For example, the HMD 1 applies control to display a cholesterol display for respective ingredients as another indicator, at positions corresponding to the respective ingredients.

(2-2-2. Gaze-Dependent Indicator Display Process)

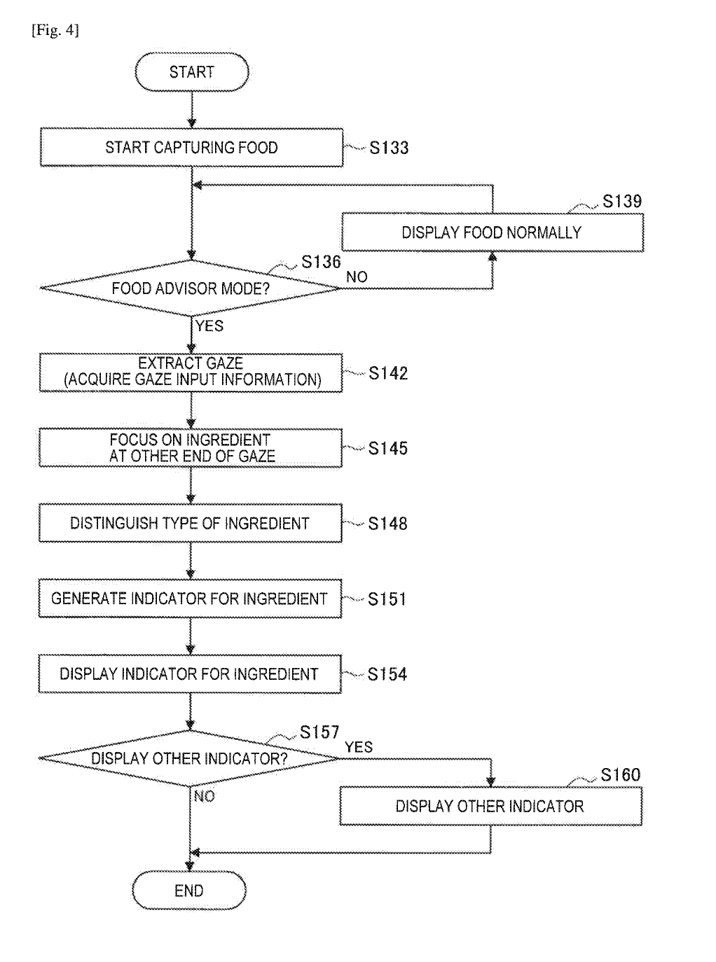

Although the indicator display process described above with reference to FIG. 3 displays indicators for respective ingredients of captured food as illustrated in FIG. 1, an indicator display process according to an embodiment is not limited thereto. For example, in the case where the HMD 1 includes a gaze input function, the HMD 1 is able to apply control to display an indicator for an indicator that a user is looking at. Hereinafter, a user's gaze-dependent indicator display process will be described with reference to FIG. 4. Note that in an embodiment, there is provided an image capture lens (not illustrated) capable of capturing a user's eye while wearing the HMD 1, for example, and the image capture unit 3 captures the user's eye with this image capture lens. Then, on the basis of a captured image, the captured image analyzer 13 tracks pupil movement, and the main controller 10 is able to extract a gaze orientation on the basis of a tracking result from the captured image analyzer 13.

FIG. 4 is a flowchart illustrating a gaze-dependent indicator display process according to an embodiment. As illustrated in FIG. 4, first, in step S133 the HMD 1 starts capturing food with the image capture unit 3.

Next, in step S136, the HMD 1 determines whether or not an eating advisor mode is set. In the example illustrated in FIG. 3 above, an indicator is hidden in the case where display rejection instructions are given after displaying an indicator (S115, S118), but an HMD 1 according to an embodiment is also capable of determining whether or not to display an indicator depending on whether or not an eating advisor mode has been set in advance.

Subsequently, in the case where the eating advisor mode is not set (S115/No), in step S139 the HMD 1 applies control to display food normally.

On the other hand, in the case where the eating advisor mode is set (S115/Yes), in step S142 the HMD 1 conducts user gaze extraction (acquisition of gaze input information). Specifically, on the basis of an eye image captured by an image capture lens (not illustrated) installed at a position able to capture a user's eye while being worn, the captured image analyzer 13 tracks pupil movement, and outputs a tracking result to the main controller 10. The main controller 10 then extracts the orientation of the user's gaze on the basis of the pupil movement tracking result.

Next, in step S145, the main controller 10 focuses on an ingredient at the end of the user's gaze, on the basis of the orientation of the user's gaze and a captured image of food. In other words, the main controller 10 selects an ingredient that the user is looking at (a specific object) as a target from among food (multiple objects) in a captured image.

Subsequently, in step S148, the type distinguishing unit 10a distinguishes the type of the ingredient (a specific object) selected as a target.

Subsequently, in step S151, the indicator generator 10c generates an indicator, such as a calorie count, for example, depending on the distinguished type of ingredient.

Then, in step S154, the display controller 17 controls the display units 2 to display an image including an indicator for the ingredient being focused on that is supplied from the output data processor 16. In this way, an HMD 1 according to an embodiment is able to apply control to display an indicator for an ingredient that the user is looking at.

Note that in the case where the user gives display instructions for another indicator (S157/Yes), in step S160 the HMD 1 applies control to display another indicator for the ingredient being focused on. For example, the HMD 1 displays, on the display units 2, a numerical cholesterol value for the ingredient being focused on as another indicator.

(2-2-3. Upper Limit-Dependent Indicator Display Process)

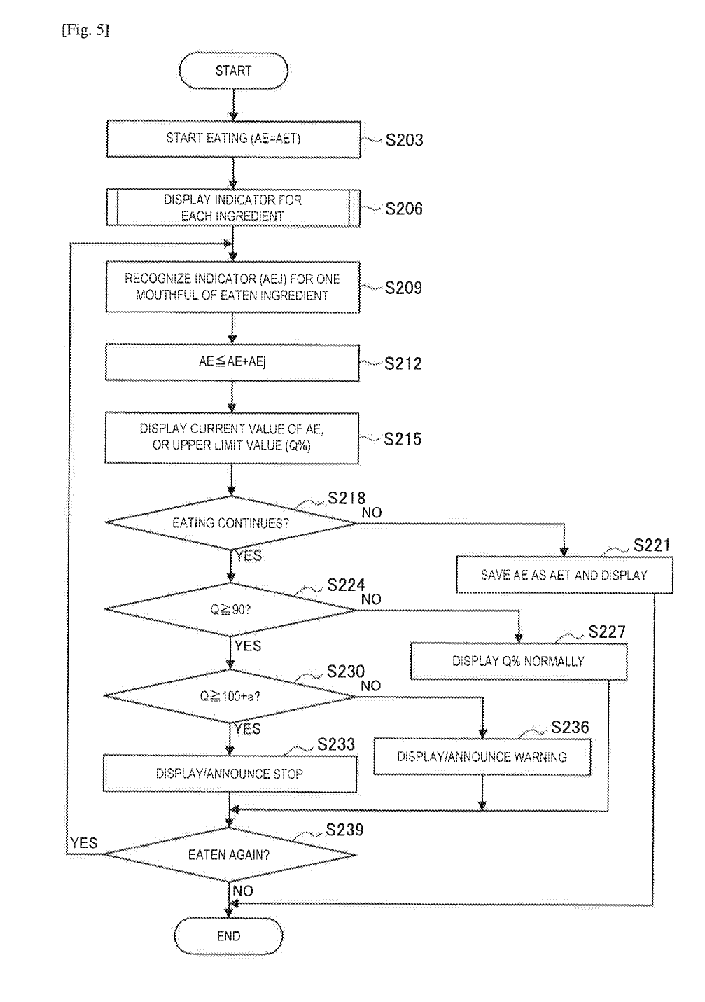

Although the respective indicator display processes described above with reference to FIGS. 3 and 4 display and present ingredient indicators to a user, in the case in which an intake upper limit value is set for a value indicated by an indicator, an HMD 1 according to an embodiment is also capable of conducting an upper limit-dependent indicator display process. For example, an HMD 1 accumulates indicators corresponding to a user's intake with the accumulation controller 10e, and after comparison against an intake upper limit value for a designated period such as one day or one week, conducts a warning display or the like. Thus, it is possible to further improve the technology for assisting a user's dietary lifestyle. Hereinafter, an upper limit-dependent indicator display process will be described with reference to FIG. 5.

FIG. 5 is a flowchart illustrating an upper limit-dependent indicator display process according to an embodiment. As illustrated in FIG. 5, first, in step S203 a user starts eating. The start of eating may be determined by the main controller 10 in the case in which food is extracted from an image captured by the image capture unit 3. Herein, AE is taken to be the intake amount of a numerical value indicated by a specific indicator (a cholesterol value, for example), and AEt is taken to be an accumulated value up to the present in a designated period. When eating starts, the main controller 10 recognizes that AE=AEt.

Next, in step S206, the HMD 1 displays indicators for respective ingredients. Specifically, the HMD 1 executes the process illustrated from S103 to S112 of FIG. 3.

Subsequently, in step S209, the main controller 10 of the HMD 1 recognizes an indicator for one mouthful of an ingredient eaten by the user. Specifically, on the basis of a captured image, the main controller 10 identifies an ingredient conveyed to the user's mouth by chopsticks, a spoon, a fork, or the like, and recognizes the indicator for that ingredient. Herein, an indicator for one mouthful (an additive value) is expressed as AEj.

Next, in step S212, the calculation unit 10f of the main controller 10 calculates an indicator value (the current value of AE) for the case of accumulating AE (equal to AEt) by AEj, and supplies the calculated result to the output data processor 16. Also, the calculation unit 10f may calculate the proportion (Q %) of the current value versus a preset intake upper limit value for a designated period. The intake upper limit value is an upper limit value on calorie intake in one day, an upper limit value on calorie intake in one week, or an upper limit value on cholesterol in one day, or the like, for example. Such an upper limit value may also be set on the basis of a user's medical information and health information.

Subsequently, in step S215, the display controller 17 controls the display units 2 to display an image including the current value of AE (AE+AEj), or the proportion (Q %) of the current value versus the upper limit value, that is supplied from the output data processor 16. Thus, the user is able to recognize the current value (AE+AEj) or the proportion (Q %) of the current value versus the upper limit value for an indicator ingested up to the present, and respond by refraining from the food in the future or the like.

Subsequently, the main controller 10 determines whether or not the user is continuing to eat. The main controller 10 determines that eating continues in the case where an action, such as the user scooping the next ingredient with a spoon, is extracted on the basis of a captured image captured by the image capture lens 3a, for example.

Next, in the case where eating does not continue and the meal has ended (S218/No), in step S221 the main controller 10 takes the AE (AE+AEj) calculated in the above S212 as the accumulated value AEt up to the present in the designated period, which is then saved in the storage unit 22 and displayed on the display units 2.

Subsequently, in the case where the user continues to eat (S218/Yes), in step S224 the main controller 10 determines whether or not the Q % displayed in the above S215 (the proportion of the current value versus the upper limit value) is 90% or greater.

Next, in the case of being below 90% (S224/No), in step S227 the main controller 10 displays the Q % displayed in the above S215 normally.

On the other hand, in the case of being 90% or greater (S224/Yes), in step S230 the main controller 10 determines whether or not the Q % displayed in the above S215 is 100+a (alpha) % or greater. In other words, the main controller 10 determines whether or not the current value of AE has exceeded the upper limit value+a (alpha).

Subsequently, in the case of being below 100+a % (S230/No), in step S236 the main controller 10 instructs the display controller 17 or the audio controller 18 to produce a warning display from the display units 2 or a warning announcement from the audio output unit 5. Thus, in the case where the current value of AE is between 90% and 100+a %, the HMD 1 issues a warning to the user, and is able to prompt the user to pay attention to his or her intake of a designated indicator (calories or cholesterol, for example).

On the other hand, in the case of 100+a % or greater (S230/Yes), in step S233 the main controller 10 instructs the display controller 17 or the audio controller 18 to produce a stop display from the display units 2 or a stop announcement from the audio output unit 5. A stop notification has a higher alert level than a warning notification. For example, the main controller 10 may cause the display units 2 to display “STOP EATING” in large letters, or cause the audio output unit 5 to output a warning sound until the user stops eating.

Subsequently, in step S239, the main controller 10 determines whether or not the user has eaten again. The main controller 10 determines that the user has eaten again in the case where an action, such as the user conveying a mouthful of an ingredient to his or her mouth, is extracted on the basis of a captured image captured by the image capture lens 3a, for example. In the case of eating again (S239/Yes), the main controller 10 again conducts the process illustrate in the above S209, and in the case of not eating again (S239/No), the process ends.

The above thus specifically describes an indicator display process according to an embodiment with reference to FIGS. 3 to 5. Note that although the example discussed above describes the case of displaying indicators depending on types of respective ingredients, embodiments are not limited thereto, and the suitability/unsuitability of respective ingredients as determined by the recommendation determination unit 10d may also be displayed for each ingredient, for example.

### 3. SCREEN DISPLAY EXAMPLES

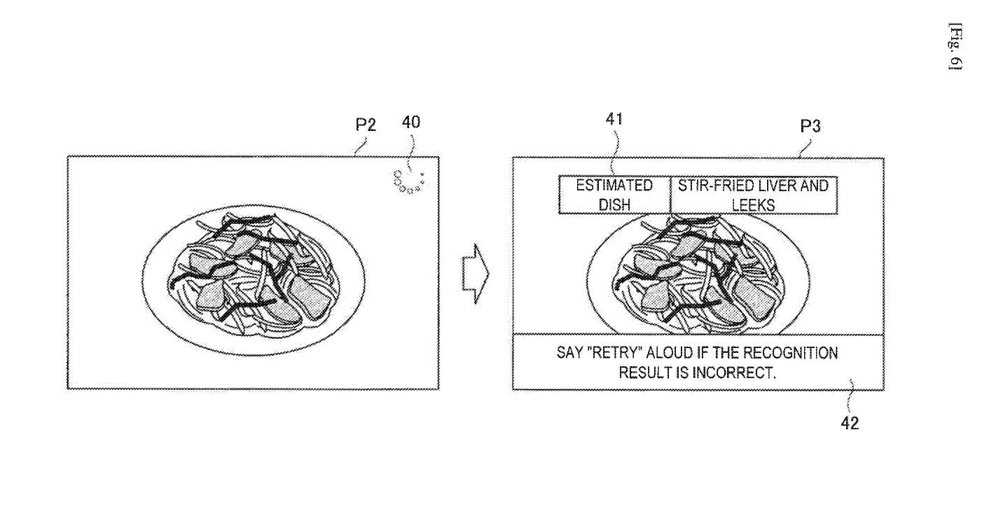

Next, screen display examples according to an embodiment will be described with reference to FIGS. 6 to 14. An HMD 1 according to an embodiment is able to assist a user's dietary lifestyle by displaying an indicator depending on a type of an ingredient, displaying a calculated result based on an accumulated indicator, and providing a display indicating the suitability/unsuitability of an ingredient.

<3-1. Indicator Display>

First, a display example of indicators for respective ingredients will be described with reference to FIGS. 6 to 10.

FIG. 6 is a diagram illustrating an example of an estimated dish confirmation screen. In an embodiment, before distinguishing the types of respective ingredients, the main controller 10 may also recognize what a dish is according to an analysis result from the captured image analyzer 13, and get confirmation from a user by displaying a recognition result on the display units 2.

Specifically, the display controller 17 displays an image 40 indicating that a captured food is being recognized, like on the display screen P2 illustrated in FIG. 6, and next displays an image 41 indicating a dish name recognized by the main controller 10, like on the display screen P3 illustrated in FIG. 6. At this point, the display controller 17 is also capable of displaying an image 42 including the text “If the recognition result is incorrect, say “Retry” out loud.”, and prompting the user to give instructions to retry recognition by voice input in the case of an incorrect result.

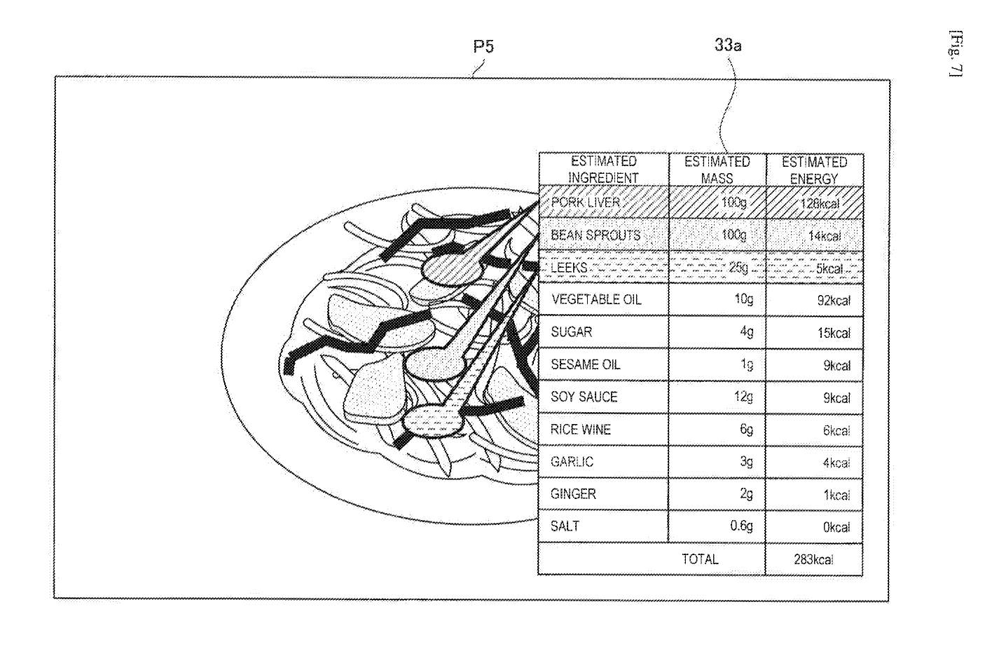

Subsequently, in the case of no retry instructions, the main controller 10 distinguishes the types of respective ingredients in a captured image with the type distinguishing unit 10a, and displays, on the display units 2, indicators for respective ingredients generated by the indicator generator 10c according to the distinguished types. Specifically, the main controller 10 displays an indicator image 33a indicating the calories and masses of respective ingredients, like on the display screen P5 illustrated in FIG. 7, for example. At this point, the display controller 17 may also display respective ingredients in correspondence with their indicators. For example, as illustrated in FIG. 7, the display controller 17 may provide a display associating pork liver and indicators for pork liver, a display associating bean sprouts and indicators for bean sprouts, as well as a display associating leeks and indicators for leeks.

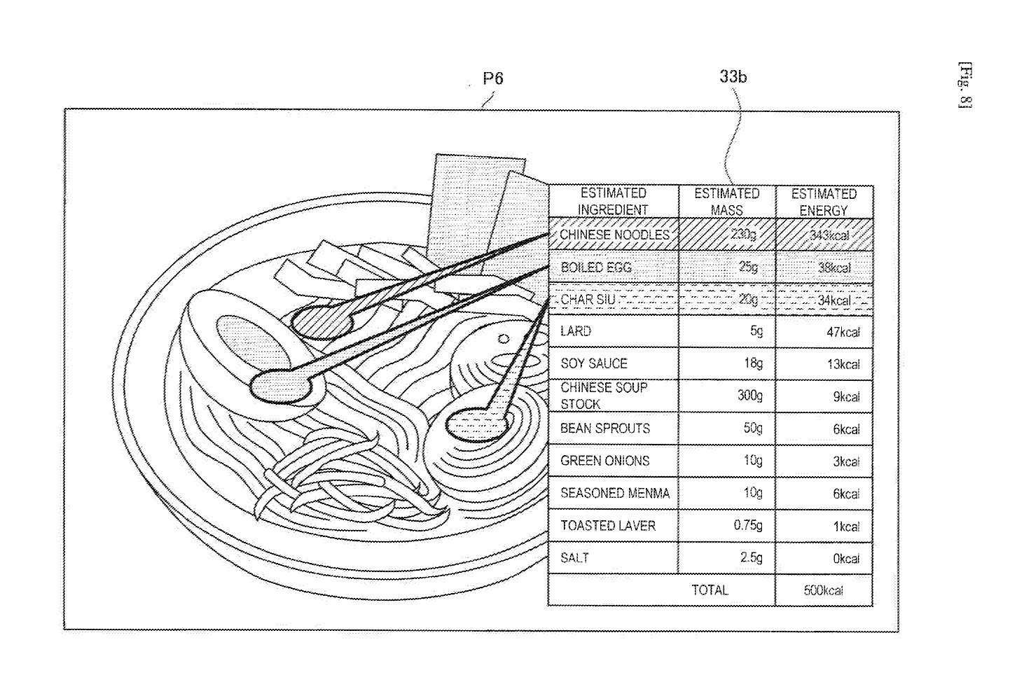

Also, FIG. 8 illustrates a display example of an indicator table image 33b indicating calories and masses for respective ingredients for the case of another food. Like on the display screen P6 illustrated in FIG. 8, when a user eats ramen, an indicator table image 33b indicating the calories and masses of respective ingredients in ramen is displayed by the main controller 10. Also, as illustrated in FIG. 8, the display controller 17 may provide a display associating noodles and indicators for noodles, a display associating boiled egg and indicators for boiled egg, and a display associating char siu and indicators for char siu.

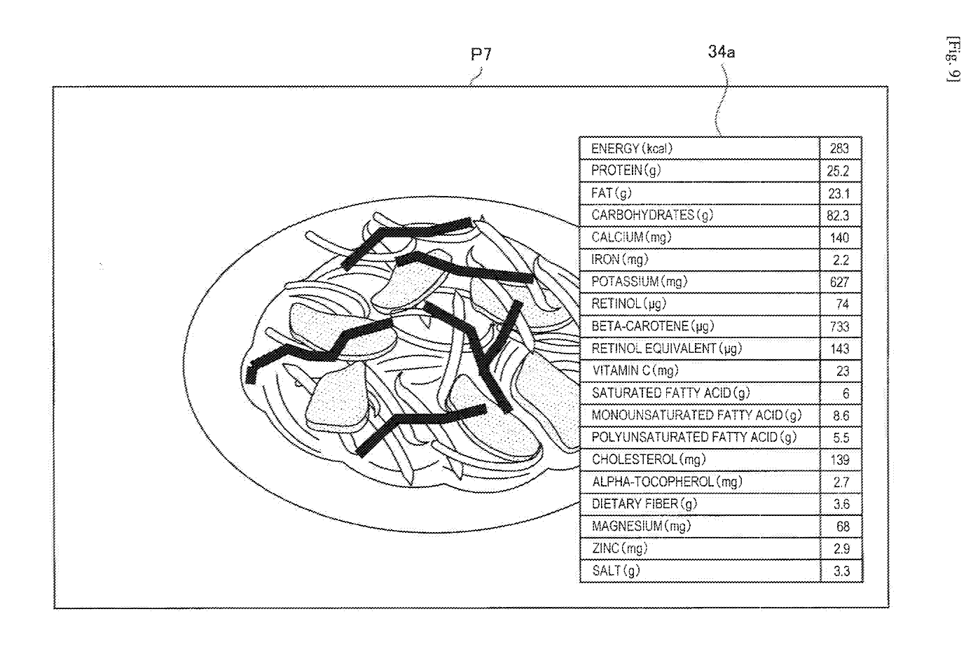

Also, an indicator table according to an embodiment is not limited to the indicator table illustrating calories and masses for respective ingredients illustrated in FIG. 7 or FIG. 8, and may also be an indicator table illustrating nutritional components, for example. Herein, FIG. 9 illustrates an example of an indicator table image 34a illustrating the nutritional components of a food. A main controller 10 according to an embodiment displays an indicator table image 34a illustrating the nutritional components of stir-fried liver and leeks, like on the display screen P7 illustrated in FIG. 9. Note that although in FIG. 9 there is displayed an indicator table image 34a illustrating the nutritional components for stir-fried liver and leeks overall as an example, a main controller 10 according to an embodiment may otherwise display an indicator image illustrating the nutritional components for respective ingredients in stir-fried liver and leeks.

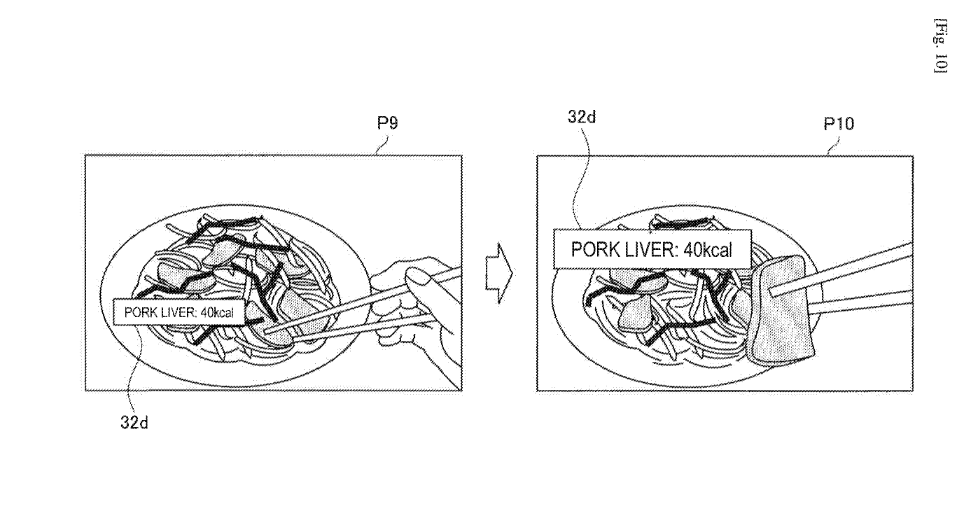

Furthermore, a main controller 10 according to an embodiment is capable of displaying an indicator for an ingredient that a user is about to eat near that ingredient, and also moving the display position of the indicator according to the positional movement of the ingredient during eating. Herein, FIG. 10 illustrates a diagram for explaining the case of displaying an indicator near an eating target.

Like on the display screen P9 illustrated in FIG. 10, a display controller 17 according to an embodiment displays an image 32d illustrating an indicator for an ingredient of an eating target (an ingredient that a user is holding between chopsticks, for example) near that ingredient. Specifically, the image capture unit 3 captures the user's eating actions, the captured image analyzer 13 analyzes a captured image, and on the basis of the analysis result, the type distinguishing unit 10a distinguishes the type of the ingredient of the eating target (pork liver, for example). Subsequently, the indicator generator 10c generates an indicator depending on the type distinguished by the type distinguishing unit 10a (the calories in one slice of pork liver, for example), which is supplied to the output data processor 16. The display controller 17 then controls the display units 2 to display an image illustrating the indicator supplied from the output data processor 16 (the image 32d illustrated in FIG. 10, for example) near the ingredient of the eating target (in the example illustrated in FIG. 10, pork liver).

Furthermore, as an ingredient of an eating target comes closer in conjunction with the user's eating actions, a display controller 17 according to an embodiment likewise moves the display position of the image 32d illustrating the indicator according to the movement of the ingredient, like on the display screen P10 illustrated in FIG. 10. Also, at this point, by gradually increasing the display size of the image 32d illustrating the indicator in accordance with the ingredient of the eating target coming closer to the user (coming closer to the HMD 1), the display controller 17 is capable of making the image 32d illustrating the indicator also appear to be coming closer to the user.

<3-2. Suitability/Unsuitability Display>

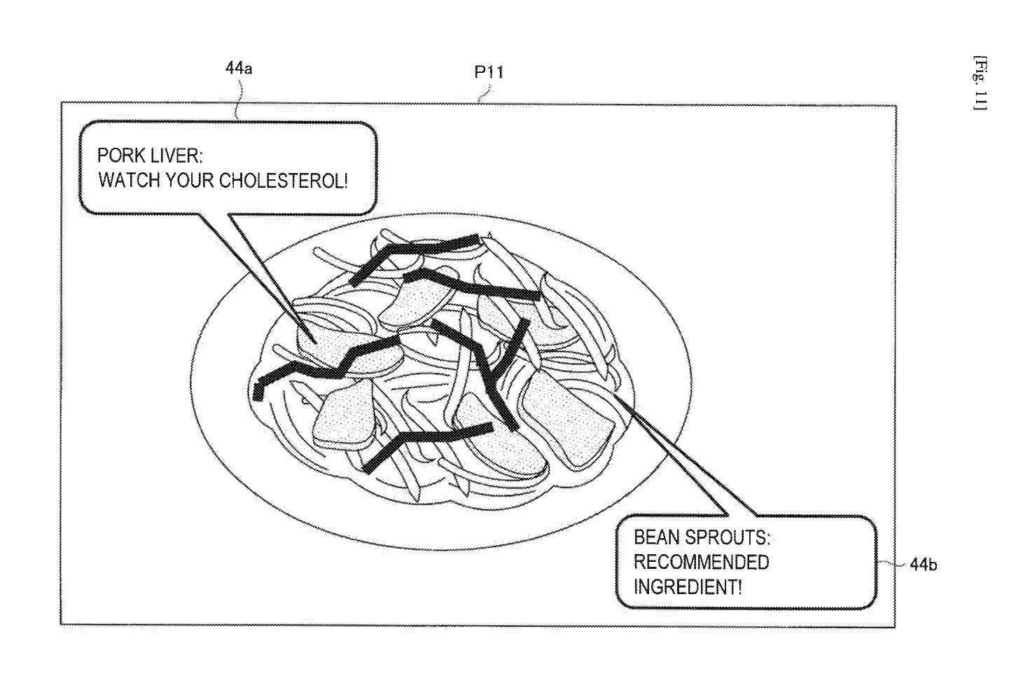

The above thus describes indicator screen display examples in detail and with reference to FIGS. 6 to 10. Next, an ingredient suitability/unsuitability display by an HMD 1 according to an embodiment will be described. As discussed above, the main controller 10 of an HMD 1 according to an embodiment includes a recommendation determination unit 10d, and the recommendation determination unit 10d determines whether or not respective ingredients are suitable for a user. Subsequently, the display controller 17 applies control to display an image illustrating whether or not respective ingredients are suitable, in correspondence with those ingredients. Hereinafter, an ingredient suitability/unsuitability display will be specifically described with reference to FIG. 11.

FIG. 11 is a diagram for explaining an ingredient suitability/unsuitability display example. As illustrated in FIG. 11, when a user is about to eat stir-fried liver and leeks, the type distinguishing unit 10a distinguishes the types of respective ingredients (leeks, pork liver, bean sprouts), and the recommendation determination unit 10d determines whether or not the respective ingredients are suitable (recommendable). Herein, in the case of ascertaining, on the basis of the user's medical information, that the user is responsible for paying attention to cholesterol, for example, the recommendation determination unit 10d determines that ingredients which are high in or which increase cholesterol are unsuitable ingredients, while ingredients which are low in or which decrease cholesterol are suitable ingredients. Specifically, the recommendation determination unit 10d determines that pork liver, being high in cholesterol, is an unsuitable ingredient, and determines that bean sprouts, being high in dietary fiber that works to decrease cholesterol, are a suitable ingredient, for example. Subsequently, the recommendation determination unit 10d supplies determination results to the output data processor 16.

The display controller 17 then applies control to display an image 44a indicating that pork liver is an unsuitable ingredient, and an image 44b indicating that bean sprouts are a suitable ingredient, like on the display screen P11 illustrated in FIG. 11. Thus, since the user is able to ascertain suitable/unsuitable ingredients for respective ingredients rather than an entire dish, the user may actively ingest suitable ingredients and take care to not ingest unsuitable ingredients. Note that in the example in FIG. 11, the text “Recommended ingredient” is displayed in the case of a suitable ingredient, and the text “Watch your cholesterol” is displayed in the case of an unsuitable ingredient. However, a suitability/unsuitability display according to embodiments is not limited to text display, and may also be displayed as “O” and “X”, for example. The display controller 17 may also display the text “Good”/“Bad”. Furthermore, the display controller 17 may also display an unsuitability level (risk level) or suitability level (recommendation level) for respective ingredients with numerical values (rating values). Also, suitability/unsuitability is not limited to being a display notification by the display controller 17, and may also be a notification via audio or vibration.

<3-3. Display of Calculated Indicator Based on Accumulated Indicator>

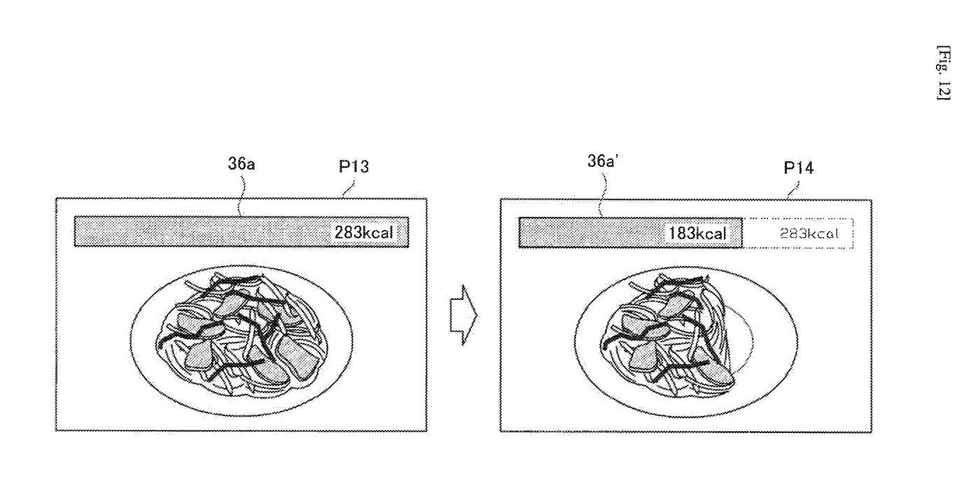

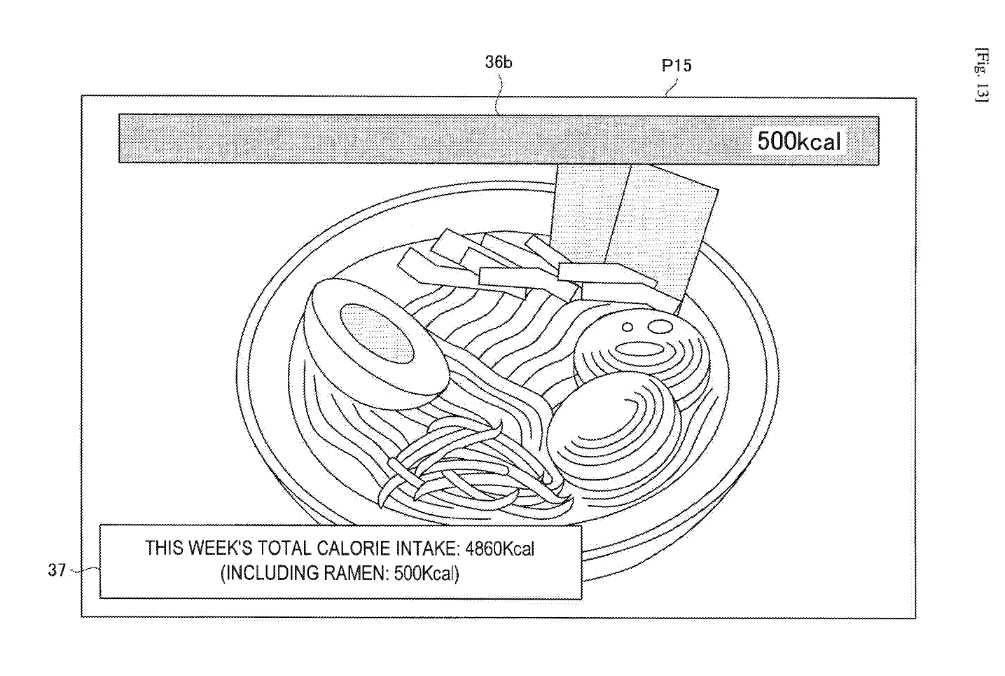

Next, the display of a calculated indicator by an HMD 1 according to an embodiment will be described. As discussed above, the main controller 10 of an HMD 1 according to an embodiment includes an accumulation controller 10e and a calculation unit 10f, and the accumulation controller 10e accumulates indicators. Also, the calculation unit 10f calculates a new indicator value based on an accumulated indicator and an indicator currently generated by the indicator generator 10c. The new indicator value is a total intake indicator for a designated period or a remaining future available intake indicator, for example. Subsequently, the display controller 17 applies control to display the calculated new indicator. Hereinafter, the display of a calculated indicator will be specifically described with reference to FIGS. 12 and 13.

FIG. 12 is a diagram for explaining the case of illustrating a remaining food indicator. A display controller 17 according to an embodiment displays an image 36a illustrating an overall food indicator as a bar, like on the display screen P13 in FIG. 12. The food indicator is a calorie count, for example, and is generated by the indicator generator 10c.

Subsequently, if the user starts eating, the indicator generator 10c of the main controller 10, on the basis of a captured image captured by the image capture unit 3, generates a calorie count corresponding to (one mouthful of) an ingredient eaten by the user, which is supplied to the accumulation controller 10e. The accumulation controller 10e accumulates the calorie count of one mouthful eaten by the user in the storage unit 22. Next, the calculation unit 10f subtracts the calorie count accumulated in the storage unit 22 since the start of eating, as well as a calorie count currently generated by the indicator generator 10c (the currently ingested calorie count), from the calorie count of the food, and calculates a remaining calorie count. The calculation unit 10f supplies the remaining calorie count calculated in this way to the output data processor 16. The display controller 17 then applies control to display an image 36a that illustrates the remaining calorie count supplied from the output data processor 16 as a bar enabling comparison with the total calorie count of the food, like on the display screen P14 illustrated in FIG. 12. Thus, the user is able to ascertain a current intake indicator in real-time while eating food.

In the example described with reference to FIG. 12 above, change in an indicator over a single meal is displayed, but a display controller 17 according to an embodiment is also able to provide a display of an indicator accumulated over a designated period such as one day or one week, or provide a display of a remaining available intake indicator for a designated period. Hereinafter, such a case will be specifically described with reference to FIG. 13.

FIG. 13 is a diagram for explaining the case of illustrating a one-week total intake indicator. A display controller 17 according to an embodiment displays, in addition to displaying an image 36b illustrating a total indicator (a total calorie count, for example) for food that the user is currently about to eat, an image 37 illustrating a calorie count of total intake over a designated period, such as one week, for example, like on the display screen P15 in FIG. 13. The calorie count of total intake over one week is the result of the calculation unit 10f adding together an intake calorie count accumulated in the storage unit 22 by the accumulation controller 10e since an initial date for one week, and the total calorie count of the food illustrated by the image 36b (the indicator currently generated by the indicator generator 10c). Thus, when eating, the user is able to intuitively ascertain a total intake indicator over a designated period such as one week.

<3-4. Display of Preparation Method-Dependent Indicators>

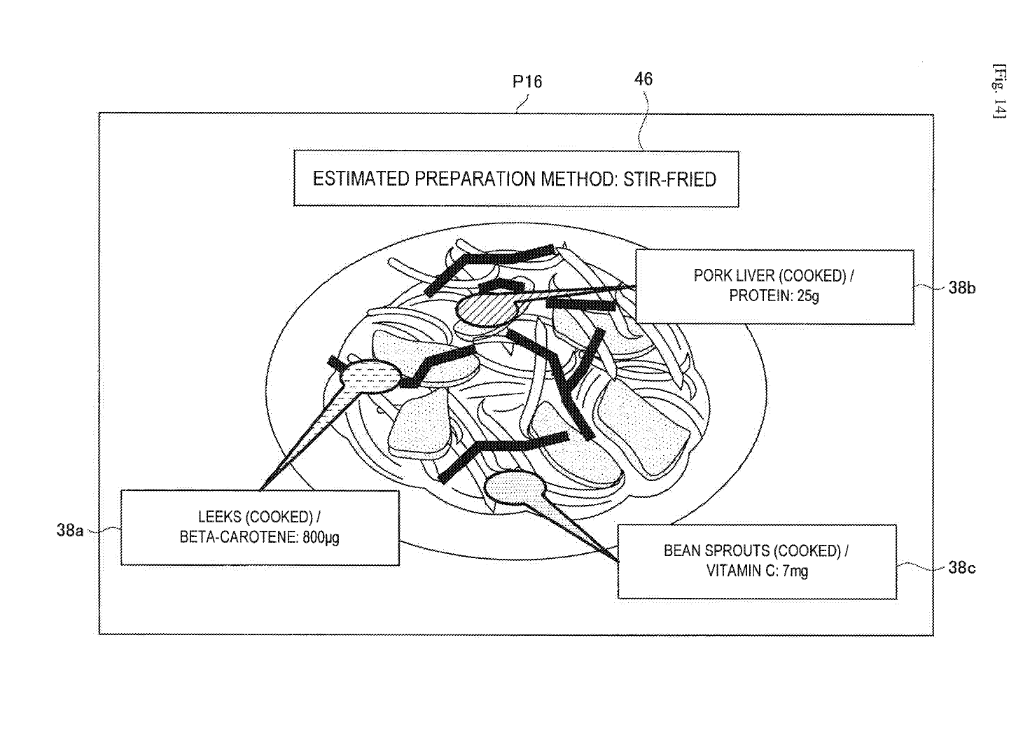

Next, the display of preparation method-dependent indicators according to an HMD 1 of an embodiment will be described. As discussed above, the main controller 10 of an HMD 1 according to an embodiment includes a preparation method distinguishing unit 10b, in which the preparation method distinguishing unit 10b distinguishes the preparation method of a food, and the indicator generator 10c re-generates indicators for respective ingredients according to the distinguished preparation method. Thus, it is possible to display indicators that also account for the case of changing according to preparation method. Hereinafter, the display of preparation method-dependent indicators will be specifically described with reference to FIG. 14.

FIG. 14 is a diagram for explaining a display of food preparation-dependent indicators. A display controller 17 according to an embodiment may display an image 46 illustrating a preparation method distinguished by the preparation method distinguishing unit 10b, and images 38a, 38b, and 38c illustrating nutritional components of respective ingredients, like on the display screen P16 illustrated in FIG. 14. In the example illustrated in FIG. 14, “stir-fried” is distinguished as the preparation method by the preparation method distinguishing unit 10, and cooked indicators for respective ingredients are generated by the indicator generator 10c. A nutritional component is illustrated as an example of an indicator. Note that the indicator generator 10c may generate a representative nutritional component from among multiple nutritional components included in an ingredient, or extract and generate a nutritional component important to the user according to the user's medical information, health information, or the like.

### 4. CONCLUSION

As discussed above, with an HMD 1 according to an embodiment, it is possible to present an indicator depending on a type of food in real-time while a user is eating.

Also, the HMD 1 may also provide a suitability/unsuitability display for respective ingredients included in the food.

Also, the HMD 1 may also present an indicator that is newly calculated on the basis of an accumulated indicator.

Furthermore, the HMD 1 may also re-generate and present an indicator depending on the dish preparation method.

The foregoing thus describes embodiments of the present technology in detail and with reference to the attached drawings. However, the present disclosure is not limited to such examples. It is clear to persons ordinarily skilled in the technical field of the present disclosure that various modifications or alterations may occur insofar as they are within the scope of the technical ideas stated in the claims, and it is to be understood that such modifications or alterations obviously belong to the technical scope of the present disclosure.

For example, it is possible to create a computer program for causing hardware such as a CPU, ROM, and RAM built into the HMD 1 to exhibit the functionality of the HMD 1 discussed earlier. A computer-readable storage medium made to store such a computer program is also provided.

Also, in the above respective embodiments, although an HMD 1 is used as an example of an information processing device, an information processing device according to an embodiment is not limited to an HMD 1, and may also be a display control system formed from a smartphone and an eyeglasses-style display, for example. The smartphone (information processing device) is connectable to the eyeglasses-style display in a wired or wireless manner, and is able to transmit and receive data.

Herein, the eyeglasses-style display includes a wearing unit having a frame structure that wraps halfway around the back of the head from either side of the head, and is worn by a user by being placed on the pinna of either ear, similarly to the HMD 1 illustrated in FIG. 1. Also, the eyeglasses-style display is configured such that, in the worn state, a pair of display units for the left eye and the right eye are placed immediately in front of either eye of the user, or in other words at the locations where the lenses of ordinary eyeglasses are positioned. By controlling the transmittance of the liquid crystal panels of the display units 2, the HMD 1 is able to set a see-through state, or in other words a transparent or semi-transparent state, and thus ordinary activities are not impaired even if the user wears the HMD 1 continuously like eyeglasses.

Also, the eyeglasses-style display is provided with an image capture lens for capturing the user's gaze direction while in the worn state, similarly to the HMD 1 illustrated in FIG. 1. The eyeglasses-style display transmits a captured image to the smartphone (information processing device).

The smartphone (information processing device) includes functions similar to the main controller 10, and distinguishes respective ingredients of food from a captured image, and generates an image illustrating indicators for distinguished ingredients. Additionally, the smartphone (information processing device) transmits a generated image to the eyeglasses-style display, and an image illustrating indicators for respective ingredients is displayed on the display units of the eyeglasses-style display.

Application is also conceivable to an eyeglass-style device that, although similar in shape to an eyeglasses-style display, does not include display functions. In this case, food is captured by a camera, provided on the eyeglasses-style device, that captures the wearer's (the user's) gaze direction, and a captured image is transmitted to the smartphone (information processing device). Subsequently, the smartphone (information processing device) generates an image illustrating indicators for respective ingredients of the food depicted in the captured image, which is displayed on a display of the smartphone.

Furthermore, although the foregoing embodiments described the type distinguishing unit 10a distinguishing types of respective ingredients and the preparation method distinguishing unit 10b distinguishing a preparation method on the basis of a captured image analysis result from the captured image analyzer 13 of the HMD 1, such a captured image analyzing process may also be conducted in the cloud. The HMD 1 sends a captured image of a dish to the cloud via the communication unit 21, receives a result that has been analyzed in the cloud (on an analysis server, for example), and on the basis thereof, conducts various distinguishing with the type distinguishing unit 10a and the preparation method distinguishing unit 10b.

Additionally, the present technology may also be configured as below.
(1) An information processing apparatus including:
circuitry configured to
obtain a captured image of food;
transmit the captured image of food;
receive, from a data providing device, at least one indication of at least one ingredient included within the food of the captured image; and
initiate a displaying of the at least one indication to a user, in association with the food of the captured image.
(2) The information processing apparatus according to (1), wherein the circuitry is further configured to initiate a displaying of a plurality of indications of a plurality of ingredients included within the food of the captured image.
(3) The information processing apparatus according to (1) or (2), wherein at least one ingredient name corresponding to the at least one ingredient is provided to be displayed in conjunction with the at least one indication.
(4) The information processing apparatus according to any of (1) through (3), wherein the circuitry is further configured to initiate a displaying of a plurality of indications associated with a plurality of ingredient names together with an accumulated value of the plurality of indications.
(5) The information processing apparatus according to any of (1) through (4), wherein the at least one indication includes an information of caloric value of the at least one ingredient.
(6) The information processing apparatus according to any of (1) through (5), wherein the at least one indication further indicates whether a respective ingredient is suitable for a health of the user.
(7) The information processing apparatus according to any of (1) through (6), wherein the user is informed of a real-time accumulated consumption of the food, according to the displayed at least one indication.
(8). The information processing apparatus according to any of (1) through (7), wherein the user is informed through display of a remaining future available indicator of consumption available of the food, the remaining future available indicator being calculated for a predetermined time period.
(9) The information processing apparatus according to any of (1) through (8), wherein the circuitry initiates the displaying of the at least one indication to the user so as to display the at least one indication as at least one augmented reality indicator that is displayed to the user in conjunction with an area in correspondence with a location of the food in real-time space.
(10) The information processing apparatus according to any of (1) through (9), wherein the circuitry initiates the displaying of the at least one indication to the user so as to display the at least one indication in conjunction with a displaying of the food displayed in the captured image.
(11) The information processing apparatus according to any of (1) through (10), wherein the at least one ingredient is selected from predetermined types of at least one of vegetables, meats, fruits, grains, seasonings, and dairy.
(12) The information processing apparatus according to any of (1) through (11), wherein the at least one ingredient is selected to be analyzed for its nutritional value, based upon detecting a focus of a gaze the user makes upon the food.
(13) The information processing apparatus according to any of (1) through (12), wherein the circuitry is further configured to obtain a smell data of the food, and the smell data is also transmitted and used in determining the at least one ingredient included within the food of the captured image.
(14) The information processing apparatus according to any of (1) through (13), wherein the circuitry is further configured to determine a preparation method of the food, and the determined preparation method is also transmitted and used in determining a nutritional value of the at least one ingredient.
(15) The information processing apparatus according to any of (1) through (14), wherein the circuitry is further configured to issue an alert to notify the user when a real-time accumulated consumption of the food exceeds a predetermined threshold in caloric intake.
(16) The information processing apparatus according to any of (1) through (15), wherein the issued alert is one of an alert instructing the user to stop eating the food and an alert notifying the user to be attentive of an accumulation status of the caloric intake.
(17) The information processing apparatus according to any of (1) through (16), wherein the information processing apparatus further includes:
an image capturing unit configured to capture the image of the food; and
a display unit configured to display the at least one indication to the user.
(18) The information processing apparatus according to any of (1) through (17), wherein the information processing apparatus is configured as a head-mounted display device.
(19) The information processing apparatus according to any of (1) through (18), further including the data providing device which is provided therewithin.
(20) A method including:
obtaining a captured image of a food;
transmitting the captured image;
receiving, from a data providing device, at least one indication of at least one ingredient included within the food of the captured image; and
displaying the at least one indication to a user, in association with the food of the captured image.
(21) A non-transitory computer-readable medium having embodied thereon a program, which when executed by a computer causes the computer to perform a method, the method including:
obtaining a captured image of a food;
transmitting the captured image;
receiving, from a data providing device, at least one indication of at least one ingredient included within the food of the captured image; and
displaying the at least one indication to a user, in association with the food of the captured image.
(22) A data providing device including:
an image obtaining unit configured to obtain a captured image of food;
a type distinguishing unit configured to distinguish at least one ingredient included within the food of the captured image;
an indicator generating unit configured to generate at least one indication in relation to the at least one ingredient; and
a display data providing unit configured to provide the generated at least one indication to be displayed in association with the food of the captured image,
wherein at least one of the image obtaining unit, the type distinguishing unit, the indicator generating unit, and the display data providing unit is implemented via a processor.
(23). The information processing apparatus according to (22), wherein the image obtaining unit is an imaging device to capture and obtain an image of food.
(24) A data providing method including:
obtaining a captured image of food;
distinguishing at least one ingredient included within the food of the captured image;
generating at least one indication in relation to the at least one ingredient; and
providing the generated at least one indication to be displayed in association with the food of the captured image.
(25) A non-transitory computer-readable medium having embodied thereon a program, which when executed by a computer causes the computer to perform a method, the method including:
obtaining a captured image of food;
distinguishing at least one ingredient included within the food of the captured image;
generating at least one indication in relation to the at least one ingredient; and
providing the generated at least one indication to be displayed in association with the food of the captured image.
(26) An information processing device including:
a type distinguishing unit that distinguishes a type of food in a captured image;
a generator that generates an indicator depending on the type of food distinguished by the type distinguishing unit; and
a display controller that applies control to display an indicator generated by the generator on a display unit.
(27) The information processing device according to (26), wherein the type distinguishing unit distinguishes a type per ingredient.
(28) The information processing device according to (27), wherein the display controller applies control to indicate suitability or not per an ingredient distinguished by the type distinguishing unit.
(29) The information processing device according to (28), further including: a notification controller that applies control to notify, by audio or vibration, suitability or not per an ingredient distinguished by the type distinguishing unit.
(30) The information processing device according to any one of (27) to (29), wherein the display controller applies control to display the indicator in correspondence with a position of an ingredient distinguished by the type distinguishing unit.
(31) The information processing device according to (30), wherein the display controller displays the indicator near an ingredient that a user is about to eat, and moves a display position of the indicator according to positional movement of the ingredient.
(32) The information processing device according to (30) or (31), wherein the display controller applies control to display the indicator in correspondence with a position of an ingredient in a real space, the real space being an image capture target.
(33) The information processing device according to (30) or (31), wherein the display controller superimposes the indicator onto the captured image in correspondence with a position of an ingredient in the captured image.
(34) The information processing device according to any one of (26) to (33), further including:
an accumulation controller that applies control to accumulate the indicator; and
a calculation unit that calculates a new indicator value based on an accumulated indicator and an indicator currently generated by the generator, and
wherein the display controller applies control to display a new indicator calculated by the calculation unit.
(35) The information processing device according to any one of (26) to (34), further including:
a preparation method distinguishing unit that distinguishes a preparation method of food in the captured image.
(36) The information processing device according to (35), wherein the generator re-generates an indicator depending on a type of the food, according to a preparation method distinguished by the preparation method distinguishing unit.
(37) The information processing device according to any one of (26) to (36), wherein the generator generates an indicator depending on a user's medical information, health information, genetic information, or predisposition information, and on a type of the food distinguished by the type distinguishing unit.
(38) The information processing device according to any one of (26) to (37), wherein the indicator is a numerical value of calories, vitamins, fat, sugar, salt content, purines, or cholesterol, a suitability level, or a risk level.
(39) A non-transitory computer-readable storage medium having a program stored therein, the program for causing a computer to function as:
a type distinguishing unit that distinguishes a type of food in a captured image;
a generator that generates an indicator depending on the type of food distinguished by the type distinguishing unit; and
a display controller that applies control to display an indicator generated by the generator on a display unit.

### REFERENCE SIGNS LIST

1 head-mounted display (HMD)
2 display unit
3 image capture unit
3a image capture lens
4 illumination unit
4a light emitter
5 audio output unit
6 audio input unit
10 main controller
10a type distinguishing unit
10b preparation method distinguishing unit
10c indicator generator
10d recommendation determination unit
10e accumulation controller
10f calculation unit
11 image capture controller
12 image capture signal processor
13 captured image analyzer
14 illumination controller
15 audio signal processor
16 output data processor
17 display controller
18 audio controller
21 communication unit
22 storage unit
P1 to P16 display screen
32a to 32c calorie display
33a, 33b indicator table image
38a to 38c image illustrating nutritional component

1. An information processing apparatus comprising:
circuitry configured to obtain a captured image of food;
transmit the captured image of food;
receive, from a data providing device, at least one indication of at least one ingredient included within the food of the captured image; and
initiate a displaying of the at least one indication to a user, in association with the food of the captured image.

2. The information processing apparatus according to claim 1, wherein the circuitry is further configured to initiate a displaying of a plurality of indications of a plurality of ingredients included within the food of the captured image.

3. The information processing apparatus according to claim 1, wherein at least one ingredient name corresponding to the at least one ingredient is provided to be displayed in conjunction with the at least one indication.

4. The information processing apparatus according to claim 3, wherein the circuitry is further configured to initiate a displaying of a plurality of indications associated with a plurality of ingredient names together with an accumulated value of the plurality of indications.

5. The information processing apparatus according to claim 1, wherein the at least one indication comprises an information of caloric value of the at least one ingredient.

6. The information processing apparatus according to claim 5, wherein the at least one indication further indicates whether a respective ingredient is suitable for a health of the user.

7. The information processing apparatus according to claim 1, wherein the user is informed of a real-time accumulated consumption of the food, according to the displayed at least one indication.

8. The information processing apparatus according to claim 7, wherein the user is informed through display of a remaining future available indicator of consumption available of the food, the remaining future available indicator being calculated for a predetermined time period.

9. The information processing apparatus according to claim 1, wherein the circuitry initiates the displaying of the at least one indication to the user so as to display the at least one indication as at least one augmented reality indicator that is displayed to the user in conjunction with an area in correspondence with a location of the food in real-time space.

10. The information processing apparatus according to claim 1, wherein the circuitry initiates the displaying of the at least one indication to the user so as to display the at least one indication in conjunction with a displaying of the food displayed in the captured image.

11. The information processing apparatus according to claim 1, wherein the at least one ingredient is selected from predetermined types of at least one of vegetables, meats, fruits, grains, seasonings, and dairy.

12. The information processing apparatus according to claim 1, wherein the at least one ingredient is selected to be analyzed for its nutritional value, based upon detecting a focus of a gaze the user makes upon the food.

13. The information processing apparatus according to claim 1, wherein the circuitry is further configured to obtain a smell data of the food, and the smell data is also transmitted and used in determining the at least one ingredient included within the food of the captured image.

14. The information processing apparatus according to claim 1, wherein the circuitry is further configured to determine a preparation method of the food, and the determined preparation method is also transmitted and used in determining a nutritional value of the at least one ingredient.

15. The information processing apparatus according to claim 1, wherein the circuitry is further configured to issue an alert to notify the user when a real-time accumulated consumption of the food exceeds a predetermined threshold in caloric intake.

16. The information processing apparatus according to claim 14, wherein the issued alert is one of an alert instructing the user to stop eating the food and an alert notifying the user to be attentive of an accumulation status of the caloric intake.

17. The information processing apparatus according to claim 1, wherein the information processing apparatus further comprises:
an image capturing unit configured to capture the image of the food; and
a display unit configured to display the at least one indication to the user.

18. The information processing apparatus according to claim 17, wherein the information processing apparatus is configured as a head-mounted display device.

19. The information processing apparatus according to claim 1, further comprising the data providing device which is provided therewithin.

20. A method comprising:
obtaining a captured image of a food;
transmitting the captured image;
receiving, from a data providing device, at least one indication of at least one ingredient included within the food of the captured image; and
displaying the at least one indication to a user, in association with the food of the captured image.

21. A non-transitory computer-readable medium having embodied thereon a program, which when executed by a computer causes the computer to perform a method, the method comprising:
obtaining a captured image of a food;
transmitting the captured image;
receiving, from a data providing device, at least one indication of at least one ingredient included within the food of the captured image; and
displaying the at least one indication to a user, in association with the food of the captured image.

22. A data providing device comprising:
an image obtaining unit configured to obtain a captured image of food;
a type distinguishing unit configured to distinguish at least one ingredient included within the food of the captured image;
an indicator generating unit configured to generate at least one indication in relation to the at least one ingredient; and
a display data providing unit configured to provide the generated at least one indication to be displayed in association with the food of the captured image,
wherein at least one of the image obtaining unit, the type distinguishing unit, the indicator generating unit, and the display data providing unit is implemented via a processor.

23. The information processing apparatus according to claim 22, wherein the image obtaining unit is an imaging device to capture and obtain an image of food.

24. A data providing method comprising:
obtaining a captured image of food;
distinguishing at least one ingredient included within the food of the captured image;
generating at least one indication in relation to the at least one ingredient; and
providing the generated at least one indication to be displayed in association with the food of the captured image.

25. A non-transitory computer-readable medium having embodied thereon a program, which when executed by a computer causes the computer to perform a method, the method comprising:
obtaining a captured image of food;
distinguishing at least one ingredient included within the food of the captured image;
generating at least one indication in relation to the at least one ingredient; and
providing the generated at least one indication to be displayed in association with the food of the captured image.
